(19) United States
(12) Patent Application Publication
(10) Pub. No.: US 2026/0336587 A1
(43) Pub. Date: Oct. 29, 2026

(54) ELECTROPNEUMATIC PARKING BRAKE SYSTEM WITH EMERGENCY BRAKING FUNCTION

(71) Applicant: ZF CV Systems Global GmbH, Bern (CH)

(72) Inventors: Malte Weber, Hannover (DE); Nikolai Flaum, Hannover (DE); Tim Schulze, Seelze (DE)

(21) Appl. No.: 19/714,960

(22) Filed: Jun. 22, 2026

Related U.S. Application Data
(63) Continuation of application No. PCT/EP2024/083571, filed on Nov. 26, 2024.

(30) Foreign Application Priority Data
Dec. 22, 2023 (DE) 10 2023 136 456.1

(51) Int. Cl. B60T 13/38; B60T 13/68

(52) U.S. Cl. CPC B60T 13/385; B60T 13/683; B60T 2270/413

(57) ABSTRACT

An electropneumatic parking brake device includes an electropneumatic parking brake valve unit. The parking brake valve unit is configured to control a parking pressure at least at one work port. The electropneumatic parking brake device further includes an electropneumatic parking brake redundancy unit. A redundancy supply port of the parking brake redundancy unit is connected to the work port of the electropneumatic parking brake valve unit. The electropneumatic parking brake redundancy unit has at least one operating position and at least one ventilation position. The electropneumatic parking brake redundancy unit can be controlled to switch from the ventilation position to the operating position by at least one first control unit. The electropneumatic parking brake redundancy unit is configured to switch to the ventilation position to provide an emergency braking function.

### CROSS-REFERENCE TO RELATED APPLICATIONS

This application is a continuation application of international patent application PCT/EP2024/083571, filed Nov. 26, 2024, designating the United States and claiming priority from German application 10 2023 136 456.1, filed Dec. 22, 2023, and the entire content of both applications is incorporated herein by reference.

### TECHNICAL FIELD

The disclosure relates to an electropneumatic parking brake device for pressurizing and venting one or more spring brake cylinders of an at least partially electronically controllable pneumatic brake system for a vehicle, comprising an electropneumatic parking brake valve unit with a supply port for receiving reservoir pressure from a compressed-air reservoir, and a parking brake control unit, wherein the parking brake valve unit is configured to control a parking brake pressure at least at one work port as a function of a parking brake signal. The disclosure further relates to an electronically controllable pneumatic brake system and a vehicle comprising such a brake system.

### BACKGROUND

Modern utility vehicles commonly have an electronically controllable pneumatic brake system. The brake system generally includes spring brakes as parking brakes, also referred to as immobilizing brakes. The parking brakes operate under the action of spring force, can be released by pressurization of spring brake cylinders with a parking brake pressure, and can be arrested by ventilation. The parking brake is usually used to secure a utility vehicle at a standstill.

Valves within a service brake system are electronically controlled in order to control a service brake pressure. The valves may be provided in, or outside, so-called axle modulators. The axle modulators may be automated or partially automated, and/or may be electronically controllable by an autonomous unit. The parking brakes are also electronically controlled. For example, the pressurization or ventilation of the spring brake cylinders can be controlled by actuation of a solenoid valve. The spring brake cylinders may be combined with service brake cylinders, such that the spring brake and service brake act on the same brake pistons. Suitable configuration measures may be implemented in order to avoid mechanical overloading of the brake pistons as a result of summation of braking forces from the service brakes and the spring brakes. If the service brakes are actuated while the parking brakes are active, the spring brake cylinders are simultaneously pressurized in order to thus avoid summation of the braking forces. Such a function is also referred to as an “anti-compound function”.

Safety concepts are of high relevance in electropneumatic brake systems for modern vehicles. In particular in vehicles with automated or partially automated driving functions, braking functions must remain available at least to a restricted degree even in the event of a fault or in the case of an electrical failure of a control unit. Only in this way can the safety of the vehicle, its occupants and other road users be ensured. For this purpose, it is known to provide redundancy levels that can continue to provide an at least restricted braking function even in the event of failure of a primary system. One way to increase reliability is to run the service brake system at least partially redundantly. The parking brake can also be used to decelerate the vehicle in an emergency. For example, if the service brake system fails, the spring brake cylinders of the vehicle can be vented to cause the vehicle to brake.

Partially redundant systems and procedures that provide redundancy are state-of-the-art in various variants. DE 10 2021 122 497 A1, for example, has disclosed a method for operating an electropneumatic brake system for a vehicle, wherein the brake system comprises a service brake system and a parking brake system, wherein the parking brake system comprises at least one spring brake cylinder. The method is characterized by the steps: providing, via a control unit, a control signal for maintaining a spring accumulator pressurization pressure with which the at least one spring brake cylinder is pressurized; stopping the provision of the control signal in the event of a fault and/or an electrical failure and/or in a diagnostic situation of the control unit; thus automatically ending the maintaining of the spring accumulator pressurization pressure in order to ventilate the at least one spring brake cylinder; thus triggering a spring accumulator failure braking operation of the vehicle via the parking brake system, with the spring accumulator pressurization pressure being vented by way of a service brake ventilation function of the service brake system. The service brake ventilation function makes it possible to realize at least one, in particular continuously or intermittently opened, ventilation path in the service brake system for the the purposes of ventilating the at least one spring brake cylinder. The service brake ventilation function is controlled in particular by a valve in the service brake system, preferably an outlet valve and/or another outlet valve is realized.

Further partially redundant systems are known from DE 10 2022 101 142 A1, DE 10 2021 122 498 A1, DE 10 2021 122 499 A1, DE 10 2020 132 875 A1 and EP 3 145 769 B1.

Even though redundant options for engaging or releasing a parking brake have already been created in part by known systems, there is a demand for possibilities for providing an emergency braking function. In particular, with the aforementioned known possibilities, an emergency braking of the vehicle in the event of the failure of one or more technical systems may not be possible or only to a limited extent.

It is therefore desirable to improve the provision of an emergency braking function. In particular, this should be done without or with only minor impairments in normal operation.

### SUMMARY

It is an object of the disclosure to specify an improved electropneumatic parking brake device, which allows the provision of an emergency braking function.

In a first aspect, the disclosure achieves this object with an electropneumatic parking brake device according to various embodiments of the disclosure. Starting from an electropneumatic parking brake device of the type mentioned above, an electropneumatic parking brake redundancy unit is further provided with a redundancy supply port, a spring accumulator port for at least indirectly connecting to a spring brake cylinder and at least a redundant ventilation. The parking brake redundancy supply port is connected to the work port of the electro-pneumatic parking brake valve unit to receive the parking pressure. The electropneumatic parking brake redundancy unit has at least one operating position in which the redundancy supply port is connected to the spring accumulator port, and at least one ventilation position in which the spring accumulator port is connected to the at least one redundant ventilation. The electropneumatic parking brake redundancy unit can be controlled for switching from the ventilation position to the operating position of at least one first control unit, wherein the electropneumatic parking brake redundancy unit is configured to provide an emergency braking function, the spring accumulator port independently of the electropneumatic parking brake valve unit for venting a spring brake cylinder connected to the spring accumulator port to connect the redundant ventilation.

In known parking brake devices, the work port of an electropneumatic parking brake valve unit is directly connected to a spring brake cylinder in order to pressurize the spring brake cylinder with the parking pressure controlled at the work port. Known parking brake valve units are typically electrically switchable in order to either pressurize or vent the spring brake cylinder depending on the situation. A problem with a known system is that the parking brake valve assembly may not be able to provide this functionality in the event of a failure. The disclosure is based on the fact that the electropneumatic parking brake redundancy unit is additionally provided. The redundancy supply port of the electropneumatic parking brake redundancy unit is connected to the work port of the electropneumatic parking brake valve unit and can thus receive the parking pressure controlled at the work port. The spring accumulator port of the electropneumatic parking brake redundancy unit can be connected at least indirectly to a spring brake cylinder. A direct connection takes place without intermediate connection of further functional units between the spring accumulator port and spring brake cylinder, whereas an indirect connection can include further functional units, such as valves in particular. However, a direct connection can include lines, for example. Thus, in the electropneumatic parking brake device according to the disclosure, between the electropneumatic parking brake valve unit and the spring accumulator port, the electropneumatic parking brake redundancy unit is still provided for connecting to at least one spring brake cylinder.

The electropneumatic parking brake redundancy unit comprises at least one operating position and one ventilation position. In the operating position, the redundancy supply port is connected to the spring accumulator port. The parking pressure controlled by the electropneumatic parking brake valve unit and the parking pressure applied to the redundancy supply port can thus be controlled through to the spring accumulator port when the electropneumatic parking brake redundancy unit is in the operating position. According to various embodiments, the electropneumatic parking brake redundancy unit is configured to control the parking pressure in the operating position substantially unchanged to the spring accumulator port. This is preferably the case when the electropneumatic parking brake redundancy unit is configured to control a pressure at the spring accumulator port that has a value that corresponds to 90% or more, preferably 95% or more, of the parking pressure. According to various embodiments, a minimum flow cross-section of the electropneumatic parking brake redundancy unit is greater than or equal to a flow cross-section of the work port in the operating position between the redundancy supply port and the spring accumulator port. In the ventilation position, the spring accumulator port is connected to at least one redundant ventilation of the electropneumatic parking brake redundancy unit. In the ventilation position, the electro-pneumatic parking brake redundancy unit can therefore vent air from a spring brake cylinder connected to the spring accumulator port.

The electropneumatic parking brake redundancy unit is configured for providing an emergency braking function independently of the electropneumatic parking brake valve unit for venting a spring brake cylinder connected to the spring accumulator port to switch to the ventilation position in order to vent a spring brake cylinder connected to the spring accumulator port via the redundant ventilation. The electropneumatic parking brake redundancy unit is preferably configured to passively switch to the ventilation position for providing the emergency braking function, that is, without providing a corresponding emergency braking signal for the electropneumatic parking brake redundancy unit. The fact that the electropneumatic parking brake redundancy unit can provide the emergency braking function independently of the electropneumatic parking brake valve unit means that it is also possible to vent a spring brake cylinder connected to the spring accumulator port if the parking brake control unit has a fault. The parking brake can then be used particularly reliably to provide emergency braking and safety is increased.

In a first embodiment of the electropneumatic parking brake device, the electropneumatic parking brake redundancy unit is configured to provide the emergency braking function if the first control unit has a fault. This provides additional fault tolerance, as the emergency braking function can be provided without a functioning first control unit. According to various embodiments, the electropneumatic parking brake redundancy unit is configured to take the ventilation position in the de-energized state. In other words, the electropneumatic parking brake redundancy unit is preferably preloaded to the ventilation position.

According to various embodiments, the electropneumatic parking brake redundancy unit at least one first electrically switchable redundancy valve, which in a first redundancy valve operating position releases the redundancy supply port to the spring accumulator port connecting first working path, so that the electropneumatic parking brake redundancy unit is in the operating position. According to various embodiments, the first electrically switchable redundancy valve in a first redundancy valve ventilation position connects the spring accumulator port with a redundant venting so that the electropneumatic parking brake redundancy unit is in the ventilation position. According to various embodiments, the first electrically switchable redundancy valve for switching from the first redundancy valve ventilation position to the first redundancy valve operating position can be actuated by the first control unit. The electropneumatic parking brake redundancy unit can thus be switched to the working position by switching the first electrically switchable redundancy valve to the first redundancy valve operating position. However, it may also be provided that at least one additional valve must be switched in order to switch the electropneumatic parking brake redundancy unit to the operating position. The electropneumatic parking brake redundancy unit can thus also be configured in such a way that the switching of the first electrically switchable redundancy valve in the redundancy valve operating position, a partial prerequisite for moving the electropneumatic parking brake redundancy unit in the operating position is. In variants it may also be provided that the electropneumatic parking brake redundancy unit can be brought into the operating position and/or the ventilation position by switching at least one of the first electrically switchable redundancy valve different from the operating position. For example, the electropneumatic parking brake redundancy unit may have multiple paths. The first electrically switchable valve can then be arranged, for example, in a first path, wherein a connection of redundancy supply port and spring accumulator port can then preferably also be carried out via an alternative second path.

In a further embodiment, the electropneumatic parking brake redundancy unit further comprises a second electrically switchable redundancy valve, which in a second redundancy valve operating position releases the second working path connecting the redundancy supply port to the spring accumulator port, so that the electropneumatic parking brake redundancy unit is in the operating position. According to various embodiments, the second electrically switchable redundancy valve may also comprise a second redundancy valve ventilation position in which it connects the spring accumulator port with a redundant ventilation, so that the electropneumatic parking brake redundancy unit is in the ventilation position. The second electrically switchable redundancy valve can be configured substantially in the same way as the first electrically switchable redundancy valve. In particular, it may also be provided that switching the second electrically switchable redundancy valve in the redundancy valve operating position is only a partial condition for switching the electropneumatic parking brake redundancy unit in the operating position, and/or that switching the second electrically switchable redundancy valve to the redundant ventilation position is only a partial condition for switching the electropneumatic parking brake redundancy unit to the ventilation position. For example, the first electrically switchable redundancy valve and the second electrically switchable redundancy valve may be connected in series, wherein the electropneumatic parking brake redundancy unit is in the operating position, if the first electrically switchable redundancy valve is in the first redundancy valve operating position and the second electrically switchable redundancy valve is in the second redundancy valve operating position. The first and second working paths can therefore also be subsections of a common working path.

According to various embodiments, however, the first electrically switchable redundancy valve and the second electrically switchable redundancy valve are arranged in parallel paths of the electropneumatic parking brake redundancy unit. Particularly According to various embodiments, the first working path and the second working path of the electropneumatic parking brake redundancy unit are parallel working paths. The first working path and the second working path are then preferably parallel working paths, which in each case form at least subsections of a compressed air path between the redundancy supply port and the spring accumulator port. It should be understood that the first and second working paths can be connected to the same redundancy supply port. In alternative embodiments, each working path can also be connected to its own or several redundancy supply ports. Furthermore, the working path and the second working path may be connected to the same spring accumulator port or to different spring accumulator ports.

In a embodiment of the variant with parallel first working path and second working path, the first working path and the second working path are connected via a selection valve, preferably adjacent to the spring accumulator port with each other. In particular, working paths connected to the spring accumulator port are connected to each other on subsections which are directly connected to the spring accumulator port, in particular not separated from the spring accumulator port by switchable valves. The selection valve is preferably configured to connect the working path from the first working path and the second working path to the spring accumulator port, which carries a higher pressure. The selection valve is thus preferably configured as a so-called select-high valve.

According to various embodiments, the electropneumatic parking brake redundancy unit for switching from the ventilation position to the operating position can be controlled by a second control unit. The electropneumatic parking brake redundancy unit can then be controlled by the first control unit and the second control unit to switch from the ventilation position to the operating position. According to various embodiments, the electropneumatic parking brake redundancy unit can be switched from the ventilation position to the operating position when this is simultaneously controlled by the first control unit and the second control unit. In other embodiments, in particular in embodiments with parallel first working path and second working path, however, it may also be provided that the electropneumatic parking brake redundancy unit can be switched from the ventilation position to the operating position by the first control unit alone and/or by the second control unit alone.

According to various embodiments, the second electrically switchable redundancy valve for switching from the second redundancy valve ventilation position to the second redundancy valve operating position can be actuated by the second control unit. According to various embodiments, the first electrically switchable redundancy valve for switching from the first redundancy valve ventilation position to the first redundancy valve operating position can be actuatable by the first control unit. For example, and According to various embodiments, the first control unit for controlling the first working path and the second control unit for controlling the second working path can be provided.

In various embodiments, the electropneumatic parking brake redundancy unit is configured to provide the emergency braking function when the first control unit has a fault or when the second control unit has a fault. Alternatively or as a supplement, the electropneumatic parking brake redundancy unit may be configured to provide the emergency braking function if the first control unit and the second control unit fail. In the event of a fault in the first control unit and/or the second control unit, the electro-pneumatic parking brake redundancy unit can provide the emergency braking function or switch to the ventilation position, thus connecting the spring accumulator port with at least one redundant ventilation.

The electropneumatic parking brake valve unit and the electropneumatic parking brake redundancy unit are preferably connected in series along a parking pressure air path. The parking pressure air path is preferably provided for pressurizing and venting at least one spring brake cylinder. The series connection of the electropneumatic parking brake valve unit and electropneumatic parking brake redundancy unit allows a high level of operational safety. For example, the electropneumatic parking brake redundancy unit can prevent a spring brake cylinder from being pressurized by a faulty electropneumatic parking brake valve unit. The electropneumatic parking brake redundancy unit is preferably arranged downstream of the electropneumatic parking brake valve unit, that is, closer to the spring brake cylinder.

In various embodiments, the electropneumatic parking brake device comprises a protective device having a first parking pressure port, a service pressure port and a work port, wherein the parking pressure port for receiving the parking pressure is connected to the spring accumulator port of the electropneumatic parking brake redundancy unit, wherein the service pressure port for receiving a service brake pressure with a service brake circuit is connectable, and wherein the protective device is configured to control the higher pressure from the parking pressure and the service brake pressure at the work port. The protective device can prevent both a service pressure and a parking pressure from being directed to a brake actuator connected to the electropneumatic parking brake device.

In a second aspect, the disclosure achieves the object stated at the outset by way of an electronically controllable pneumatic brake system for a vehicle, in particular a utility vehicle. The electronically controllable pneumatic brake system comprises at least one parking brake actuator with a spring brake cylinder, a first compressed-air reservoir for providing reservoir pressure, and an electropneumatic parking brake device according to one of the embodiments described above according to the first aspect of the disclosure. The supply port of the electropneumatic parking brake valve unit is connected to the first compressed-air reservoir and the spring accumulator port of the electropneumatic parking brake redundancy unit is connected to the spring brake cylinder. For pressurizing the spring brake cylinder, compressed air supplied by the compressed-air reservoir can be provided via the electropneumatic parking brake device on the spring brake cylinder. The electropneumatic parking brake device can pass the reservoir pressure unchanged or modulate it in pressure level and/or volume flow.

In a first embodiment, the electronically controllable pneumatic brake system comprises an electropneumatic parking brake device, which can be controlled by a second control unit for switching from the ventilation position to the operating position, wherein the electropneumatic parking brake redundancy unit is configured to provide the emergency braking function only, If the first control unit and the second control unit have a fault. According to a further embodiment, the spring brake cylinder connected to the spring accumulator port is therefore only connected by the electropneumatic parking brake redundancy unit with at least one redundant ventilation if both the first control unit and the second control unit have a fault. For example, a control unit may fail if it is not supplied with electrical power, if it has a software fault, and/or if it has a hardware fault, such as a broken cable.

According to various embodiments, the electronically controllable brake system further comprises a first voltage source and a second voltage source, wherein the first voltage source for supplying the first control unit with electrical voltage is provided. According to various embodiments, the second voltage source is provided for supplying the second control unit with electrical voltage. The first voltage source and the second voltage source are preferably independent voltage sources. The provision of mutually independent voltage sources can further increase the fail-safety of the brake system, because a failure of a single voltage source does not result in a total failure of the parking brake system.

In a variant of the electronically controllable brake system, the first control unit can switch the electropneumatic parking brake redundancy unit from the ventilation position to the operating position only if the first voltage source and the second voltage source provide electrical energy. It should be understood that the first control unit does not need to be supplied with electrical energy from both the first voltage source and the second voltage source. For example, the first control unit can only be powered from the first voltage source. In such embodiments, however, it may be advantageous that the first control unit can switch the electropneumatic parking brake redundancy unit from the ventilation position to the operating position only if both voltage sources provide electrical energy. Thus, the first control unit may also still be operational in case of failure of the second voltage source while a system safety is already reduced and a pressurization of the spring-loaded brakes is therefore undesirable.

According to various embodiments, the electronically controllable pneumatic brake system further comprises a unit for autonomous driving, wherein the unit for autonomous driving is the first control unit. A unit for autonomous driving may in particular be a so-called be a virtual driver that generates driving commands on the basis of sensor data, operating data, route data, setpoint data and similar data and provides these to the vehicle. Driving commands may include steering commands, acceleration commands and braking commands, in particular a braking demand AB.

In alternative embodiments, the electronically controllable pneumatic brake system comprises at least one service brake actuator and a service brake system with a service brake control unit at least for controlling the at least one service brake actuator, wherein the service brake control unit is the first control unit. The service brake control unit is typically independent of the parking brake control unit.

According to various embodiments, the electronically controllable pneumatic brake system in addition to the service brake system further comprises a secondary system with a secondary control unit, wherein the secondary system is configured to control the at least one service brake actuator, if a fault is detected in the service brake system. The secondary system can also be called a service brake redundancy system.

In variants in which the electronically controllable pneumatic brake system comprises a secondary system and in which the electropneumatic parking brake redundancy unit of the electropneumatic parking brake device of the electronically controllable pneumatic brake system for switching from the ventilation position to the operating position can be controlled by a second control unit, the secondary control unit may be or comprise the second control unit. In this variant, an existing control unit can then be used to control the electropneumatic parking brake redundancy unit.

In variants in which a unit for autonomous driving of the electronically controllable pneumatic brake system is or comprises the first control unit, the electronically controllable pneumatic brake system may comprise at least one service brake actuator and a service brake system having a service brake control unit at least for controlling the at least one service brake actuator. The service brake control unit is then preferably the second control unit. For example, two units already present in the brake system can be used to control the electropneumatic parking redundancy unit for switching from the ventilation position to the operating position. According to various embodiments, the electropneumatic parking redundancy unit is configured to automatically switch to the ventilation position in case the autonomous driving unit (the first control unit) or the service brake control unit (the second control unit) have a fault. In alternative embodiments, the electropneumatic parking redundancy unit is configured to automatically switch to the ventilation position if the autonomous driving unit (the first control unit) and the service brake control unit (the second control unit) have a fault.

According to a third aspect of the disclosure, the object mentioned in the introduction is achieved by a utility vehicle, having at least one front axle, at least one first rear axle and an electronically controllable pneumatic brake system according to any one of the above-described embodiments of an electronically controllable pneumatic brake system according to the second aspect of the disclosure. In a fourth aspect, the disclosure satisfies the object mentioned in the introduction by a method for operating an electronically controllable pneumatic brake system for a vehicle comprising a first control unit and a parking brake system with at least one spring brake cylinder and an electropneumatic parking brake device. In particular, the method is a method for operating an electronically controllable pneumatic brake system according to one of the embodiments of an electronically controllable pneumatic brake system described above according to the second aspect of the disclosure. The method according to the fourth aspect of the disclosure comprises the following steps: providing at least one redundancy switching signal to an electropneumatic parking brake redundancy unit of the electropneumatic parking brake device; switching the parking brake redundancy unit to an operating position in response to providing the at least one redundancy switching signal; providing a parking brake signal to a parking brake control unit of an electropneumatic parking brake valve unit of the electropneumatic parking brake device; controlling a parking pressure by the electropneumatic parking brake valve unit at a work port of the electropneumatic parking brake valve unit as a function of the parking brake signal provided at the parking brake control unit; passing the parking pressure controlled at the work port from a redundancy supply port of the parking brake redundancy unit to a spring accumulator port of the parking brake redundancy unit, pressurizing a spring brake cylinder connected to the spring accumulator port of the parking brake redundancy unit; and, automatically and independently of the electro-pneumatic parking brake valve unit, independently switching the parking brake redundancy unit from the operating position to a ventilation position, in which the spring accumulator port is connected to a redundant ventilation of the parking brake redundancy unit to vent the spring brake cylinder to provide emergency braking. By switching the parking brake redundancy unit from the operating position to the ventilation position, the spring accumulator port is connected to the redundant ventilation and the spring brake cylinder connected to the spring accumulator port is vented. This causes the parking brake to be applied and the vehicle to brake. The switching of the parking brake redundancy unit for providing the emergency braking function is preferably carried out if a supply of the parking brake redundancy unit with electrical energy and/or redundancy switching signals is interrupted and/or if the provision of at least one redundancy switching signal is omitted. According to various embodiments, the parking brake valve unit automatically switches from the operating position to the ventilation position for providing the emergency braking function. If a first control unit for controlling the electropneumatic parking brake redundancy unit and/or a second control unit for driving the electropneumatic parking brake redundancy unit has a fault. As an alternative or in addition, automatic shifting can also be carried out in the event of a failure of a first voltage source and/or a second voltage source of the brake system.

When passing the parking pressure, the parking pressure can also be varied in terms of pressure level and/or volume flow. However, it is particularly preferred to pass through without any significant influence on the parking pressure, which goes beyond the usual pressure losses in line components.

It should be understood that the electronically controllable pneumatic brake system according to the second aspect of the disclosure, the utility vehicle according to the third aspect of the disclosure and the method for operating an electronically controllable pneumatic brake system according to the fourth aspect of the disclosure have the same and similar sub-aspects.

### BRIEF DESCRIPTION OF DRAWINGS

The invention will now be described with reference to the drawings wherein:

FIG. 1 is a schematic illustration of a utility vehicle with an electronically controllable pneumatic brake system;

FIG. 2 shows a first embodiment of an electropneumatic parking brake device;

FIG. 3 shows a second embodiment of an electropneumatic parking brake device; and,

FIG. 4 shows a block diagram illustrating a method for operating an electronically controllable pneumatic brake system.

### DETAILED DESCRIPTION

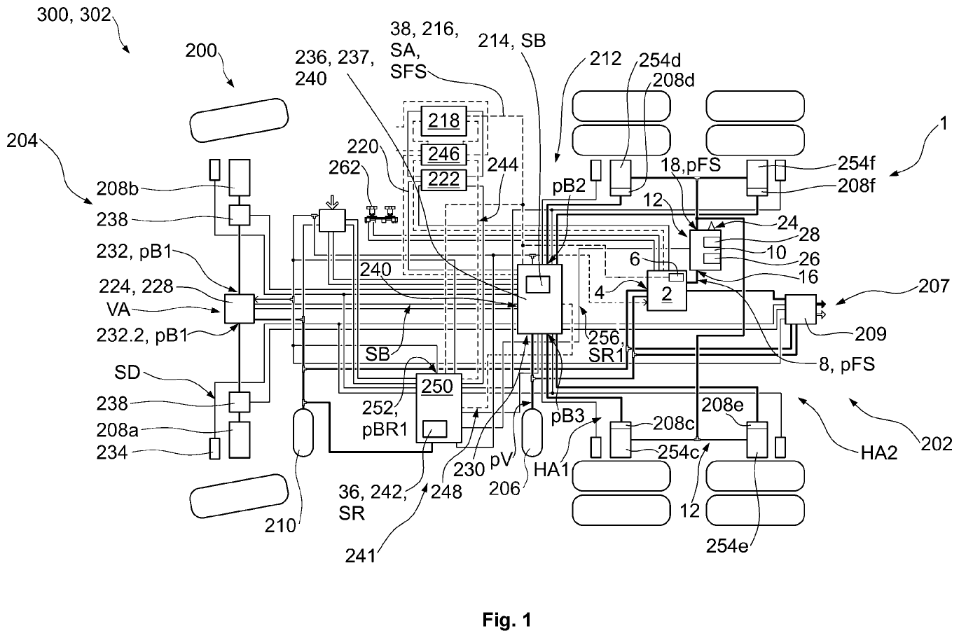

FIG. 1 shows an electronically controllable pneumatic brake system 200 having an electropneumatic parking brake device 1. The electronically controllable pneumatic brake system 200 is used in the present case in a vehicle 300 configured as a utility vehicle 302, which is illustrated here in highly schematic form, in particular with a front axle VA, a first rear axle HA1 and a second rear axle HA2.

The electronically controllable pneumatic brake system 200 has first, second, third, fourth, fifth and sixth service brake actuators 208a-208f, for in each case one wheel of the vehicle 300. To supply the first to sixth service brake actuators 208a-208f with brake pressures, a rear axle brake circuit 202 and a front axle brake circuit 204 are provided. The service brake actuators 208a, 208b are assigned to the front axle VA and are therefore also referred to as front axle brake actuators 208a, 208b. Similarly, the service brake actuators 208c-208f assigned to the rear axles HA1, HA2 are also referred to as the rear axle brake actuators 208c-208f. The rear axle brake circuit 202 is supplied by a first compressed-air reservoir 206 and the front axle brake circuit 204 by a second compressed-air reservoir 210. The utility vehicle 300 is configured here as a towing vehicle and comprises a trailer brake circuit 207 with a trailer module 209, which is provided for supplying a trailer connected to the utility vehicle 300 (not shown) with compressed air.

The electronically controllable pneumatic brake system 200 has a service level and a first redundancy level. In the service level, the electronically controllable pneumatic brake system 200 comprises a service brake system 212 having an electronic service brake control unit 214 that controls the electronically controllable pneumatic brake system 200 in the service level. The electronic service brake control unit 214 is connected via a vehicle bus 216 to an autonomous driving unit 218 and receives brake request signals SA from this. Furthermore, the electronic service brake control unit 214 is connected via a first supply line 220 to a first voltage source 222 and is supplied with electrical power therefrom. The electronic service brake control unit 214 converts the brake request signals SA and, based on this, outputs operating brake signals SB on a first service axle modulator 224. The first service axle modulator 224 is a front axle modulator 228 intended for the front axle VA. Alternatively or in addition, brake request signals SA can also be provided by an electronic foot brake pedal 264 on the service brake control unit 214.

The first service axle modulator 224 is connected to the second compressed-air reservoir 210 and receives reservoir pressure pV therefrom. On the basis of the received service brake signals SB, the first service axle modulator 224 controls a first service brake pressure pB1 at a first service brake pressure port 232.1 and preferably a second service brake port 232.2. The first service brake pressure pB1 is preferably modulated on a wheel-specific basis at the first and second service brake pressure ports 232.1, 232.2, and the first service axle modulator 224 is configured as a two-channel modulator. In other embodiments, the first service brake pressure port 232.1 and the second service brake pressure port 232.2 may however also be combined, and the first service axle modulator 224 may thus be configured as a single-channel axle modulator, which modulates the first service brake pressure pB1 on an axle-specific basis.

On the front axle VA, a first wheel speed sensor 234 is also provided, which provides first wheel speed signals SD at the service brake control unit 214. The service brake control unit 214 is configured to process the first wheel speed signals SD and to provide ABS switching signal to ABS valves 238 of the front axle VA in order to achieve slip control or ABS modulation of the first service brake pressure pB1 and to avoid blockage of the front wheels of the vehicle 300.

Furthermore, the electronically controllable pneumatic braking system 200 comprises a second service axle modulator 236 in the service level, which is provided for the first and second rear axles HA1, HA2 and can thus also be referred to as the rear axle modulator 237. In the embodiment shown in FIG. 1, the rear axle modulator 237 is installed with the electronic service brake control unit 214 to a module, which is referred to here as central module 240. However, it should be understood that the rear axle modulator 237 and the service brake control unit 214 can also be separate or structurally separate. The service brake control unit 214 and the rear axle modulator 237 can then be connected to each other, for example, via a signal line or a bus line. Internally, the service brake electronic control unit 214 controls the rear axle modulator 237 in accordance with the brake request signals SA received by the service brake control unit 214 from the autonomous driving unit 218.

A service reservoir port 230 of the second service axle modulator 236 is connected to the first compressed-air reservoir 206 and receives reservoir pressure pV from this. According to its activation by the service brake control unit 214, the rear axle modulator 237 controls at least a second service brake pressure pB2, but in the embodiment shown here, it also controls a third service brake pressure pB3. The second service brake pressure pB2 is provided for the right side of the vehicle in the embodiment shown in FIG. 1 and the third service brake pressure pB3 is provided for the left side of the vehicle. The rear axle modulator 237 is thus configured here as a two-channel axle modulator. The second service brake pressure pB2 is intended for a fourth and sixth service brake actuator 208d, 208f, while the third service brake pressure pB3 is provided for a third and a fifth service brake actuator 208c, 208e. In other variants, the first service axle modulator 236 can also be configured as a single-channel modulator or as a multi-channel modulator with more than two outputs.

In the redundancy level, the electronically controllable pneumatic brake system 200 comprises a secondary control unit 242 of a secondary system 241, which is provided for controlling the electronically controllable pneumatic brake system 200 in the event that the service level has one or more faults. The secondary control unit 242 can thus control the electronically controllable pneumatic brake system 200 for example in the event of an electrical failure in the first voltage source 222, an electronic fault in the service brake control unit 214, or the like.

The electronic secondary control unit 242 is likewise connected via the vehicle bus 216 to the unit for autonomous driving 218, and from this likewise receives braking demand signals SA. In contrast to the service brake control unit 214, the secondary control unit 242 is connected via a second supply line 244 to a second voltage source 246 and is supplied with electrical energy from this. The first and the second voltage sources 222, 246 are independent of one another, such that a failure in the first voltage source 222 does not lead to a loss of the second voltage source 246, and vice versa. The electronic service brake control unit 214 and the electronic secondary control unit 242 are thus electrically independent of one another.

To be able to exchange signals, the service brake control unit 214 and the secondary control unit 242 are connected to one another via a redundancy bus 248. In this way, the secondary control unit 242 can determine the availability of the service brake control unit 214, and perform the control of the electronically controllable pneumatic brake system 200 only if the service brake control unit 214 is not available or not properly available. In variants, however, communication between the service brake control unit 214 and the secondary control unit 242 may for example also take place via the vehicle bus 216.

In the redundancy level, a redundancy axle modulator 250 is provided, which is connected to the secondary control unit 242 and receives redundancy braking signals SR from this. In the embodiment according to FIG. 1, the secondary control unit 242 is integrated into the redundancy axle modulator 250. In other variants, the secondary control unit 242 and the redundancy axle modulator 250 may however also be physically separate units.

The redundancy axle modulator 250 is connected to the second compressed-air reservoir 210, which is independent of the first compressed-air reservoir 206, such that the second compressed-air reservoir 210 can provide reservoir pressure pV even if the first compressed-air reservoir 206 has failed. In other embodiments, the redundancy axle modulator 250 can also be connected to the second compressed-air reservoir 210 or to the first compressed-air reservoir 206 and the second compressed-air reservoir 210.

The redundancy axle modulator 250 controls a redundancy brake pressure pBR1 at a redundancy brake pressure port 252 in accordance with the redundancy brake signals SR. The redundancy brake pressure pBR1 controlled at the redundancy brake pressure port 252 is provided to the front axle modulator 228. The redundancy axle modulator 250 is shown in FIG. 1 as a single-channel axle modulator with only one redundancy brake pressure port 252, but may also be configured as a multi-channel axle modulator, which can, for example, implement a side-appropriate control of redundancy brake pressures.

The secondary control unit 242 can control the redundancy axle modulator 250 in such a way that in the event of a fault of the service brake control unit 214, a brake pressure, namely the redundancy brake pressure pBR1 is provided at the front axle brake actuators 208a, 208b. Unlike that shown in FIG. 1, the redundancy level can also be provided for braking the first and second rear axles HA1, HA2. This can be realized via the redundancy axle modulator 250 or via a second redundancy axle modulator. The secondary control unit 242 can then preferably also be provided for controlling such a second redundancy axle modulator.

The brake actuators assigned to the wheels of the rear axles HA1, HA2, in the embodiment shown in FIG. 1 of the electronically controllable pneumatic brake system 200, are formed as double-acting brake actuators, which are also referred to as tri-stop cylinders. Aside from the service brake actuators 208c-208f, these each also comprise a spring brake cylinder 254c-254f. The spring brake cylinders 254c-254f are configured to apply the brakes of the vehicle 300 when unpressurized or ventilated. The spring brake cylinders 254c-254f can thus advantageously be utilized as parking brakes, because no compressed air needs to be provided in order to brake the rear axles HA1, HA2. To release the rear wheels, the spring brake cylinders 254c-254f must be pressurized with a parking brake pressure pFS. This parking brake pressure pFS acts counter to the spring accumulators and releases the brakes of the vehicle 300. The spring brake cylinders 254c-254f are part of a parking brake system 203.

To provide the parking brake function, the electronically controllable pneumatic brake system 200 comprises the electropneumatic parking brake device 1. This comprises an electropneumatic parking brake valve unit 2, which is supplied with reservoir pressure pV via a supply port 4. In the embodiment shown, the supply port 4 is connected to the first compressed-air reservoir 206. The parking brake valve unit 2 could also be supplied with reservoir pressure pV from the second compressed-air reservoir 210.

The electropneumatic parking brake valve unit 2 comprises a parking brake control unit 6 that is connected via the vehicle bus 216 to the unit for autonomous driving 218. To engage the parking brake, the unit for autonomous driving 218 provides a parking brake signal SFS to the parking brake control unit 6 via the vehicle bus 216, and the parking brake control unit thereupon provides the parking brake pressure pFS at a work port 8.

The work port 8 of the electropneumatic parking brake valve unit 2 is connected in FIG. 1 with a redundancy supply port 16 of an electropneumatic parking brake redundancy unit 10 of the electropneumatic parking brake device 1. The electropneumatic parking brake valve unit 2 controls the parking pressure pFS at its work port 8 in response to the parking brake signals SFS and thus provides this at the redundancy supply port 16. The electropneumatic parking brake redundancy unit 10 further comprises a spring accumulator port 18, which in FIG. 1 is directly connected to the spring brake cylinders 208c, 208d, 208e, 208f of the electronically controllable pneumatic brake system 200.

The electropneumatic parking brake valve unit 2 and the electropneumatic parking brake redundancy unit 10 are thus connected in series along a parking pressure air path 12 in the embodiment shown, which is provided here for supplying the spring brake cylinders 208c, 208d, 208e, 208f with parking pressure pFS. In particular, the electropneumatic parking brake valve unit 2 in the embodiment shown in FIG. 1 is connected only via the electropneumatic parking brake redundancy unit 10 with the spring brake cylinders 208c, 208d, 208e, 208f. The electropneumatic parking brake valve unit 2 can supply the spring brake cylinders 208c, 208d, 208e, 208f, that is, not past the electropneumatic parking brake redundancy unit 10, with parking pressure pFS.

The electropneumatic parking brake redundancy unit 10 can be switched between an operating position 20 and a ventilation position 22.

In the operating position 20, the electropneumatic parking brake redundancy unit 10 connects the redundancy supply port 16 to the spring accumulator port 18. Here, the electropneumatic parking brake redundancy unit 10 controls the parking pressure pFS provided at the redundancy supply port 16 substantially unchanged to the spring accumulator port 18 when it is in the operating position 20. In this case, the parking pressure pFS is also applied to the spring accumulator port 18 and can thus be provided on the spring brake cylinders 208c, 208d, 208e, 208f.

In the ventilation position 22, on the other hand, the spring accumulator port 18 is connected to a redundant ventilation 24 of the electropneumatic parking brake redundancy unit 10. In the ventilation position 22, the electropneumatic parking brake redundancy unit 10 immediately ventilates the spring brake cylinders 208c, 208d, 208e, 208f connected to the spring accumulator port 18 into the environment. Therefore, if the electropneumatic parking brake redundancy unit 10 is in the ventilation position 22, the parking brake of the vehicle 300 is applied or the wheels of the rear axles HA1 and HA2 of the vehicle 300 are braked.

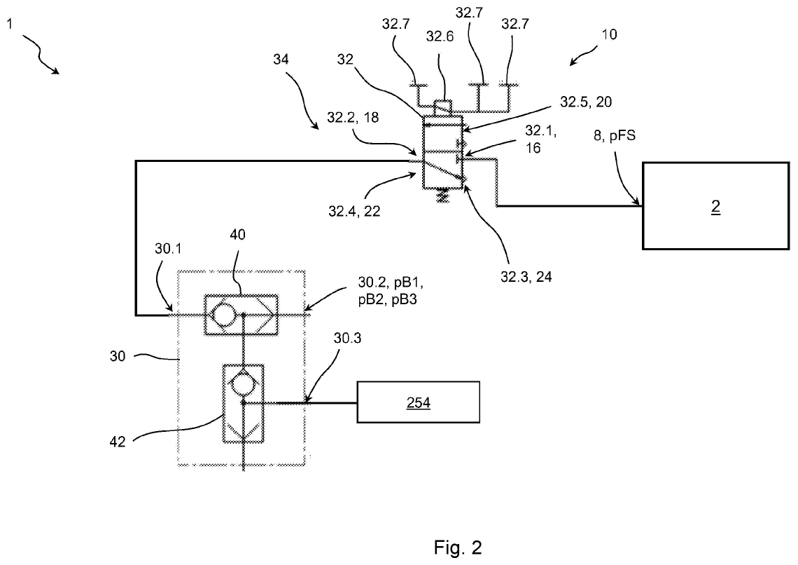

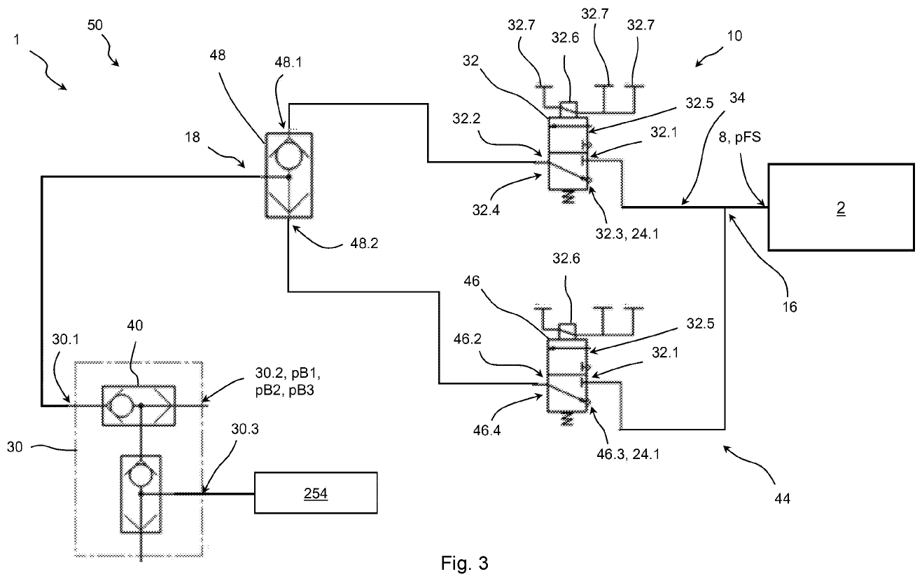

In FIG. 1, a first electrically switchable redundancy valve 26 and a second electrically switchable redundancy valve 28 of the electropneumatic parking brake redundancy unit 10 are also indicated. The structure of the electropneumatic parking brake redundancy unit 10 will be further explained at a later point with reference to FIG. 2 and FIG. 3.

The electropneumatic parking brake redundancy unit 10 can be controlled for switching from the ventilation position 22 to the operating position 20 by at least one control unit of the electronically controllable pneumatic brake system 200. For this purpose, the electropneumatic parking brake redundancy unit 10 in FIG. 1 is connected, for example, to the secondary control unit 242 via a first redundancy signal line 256. This provides a first redundancy switching signal SR1 to the electropneumatic parking brake redundancy unit 10 via the redundancy signal line 256.

In FIG. 1, the spring brake cylinders 254c-254f are directly connected to the spring accumulator port 18. In a variant, the electropneumatic parking brake device 1, however, may additionally comprise a protective device 30 (FIG. 3), which is arranged between the spring accumulator port 18 and the spring brake cylinders 254c-254f or between the work port 8 and the redundancy supply port 16.

According to various embodiments, the electropneumatic parking redundancy unit 10 is switched from the ventilation position 22 to the operating position 20 during the commissioning of the vehicle 300, in particular when actuating an ignition of the vehicle 300. The electropneumatic parking brake valve unit 2 can then pressurize the spring brake cylinders 254c, 254d, 254e, 254f via the electropneumatic parking redundancy unit 10 and thus release the parking brake of the vehicle 300. The vehicle 300 is then ready to drive. According to various embodiments, the electropneumatic parking redundancy unit 10 is kept permanently in the operating position 20 in normal operation. Any necessary venting of the spring brake cylinders can then be carried out 254c, 254d, 254e, 254f via the electropneumatic parking brake valve unit 2. The electropneumatic parking redundancy unit 10 switches preferably only then to provide an emergency braking function in the ventilation position 22, when there is a fault, in particular in the event of an electrical total failure of the electronically controllable pneumatic brake system 200 or in the event of a failure of several control units 6, 214, 218, 242 of the electronically controllable pneumatic brake system 200.

Although in the embodiment shown in FIG. 1 only the secondary control unit 242 for controlling the electropneumatic parking redundancy unit 10 is shown, it is intended to be understood, that the electropneumatic parking redundancy unit 10 can also be controlled individually or combined by further control units of the electronically controllable pneumatic brake system 200 in order to switch from the ventilation position 22 to the operating position 20. In particular, the electropneumatic parking redundancy unit 10 can also be controlled by the unit for autonomous driving 218 and/or the service brake control unit 214.

FIG. 2 now schematically shows a first embodiment of the electropneumatic parking brake device 1. The electropneumatic parking brake valve unit 2 is shown only schematically. Furthermore, FIG. 2 shows an example of only one spring brake cylinder 254. The electropneumatic parking redundancy unit 10 comprises only one first electrically switchable redundancy valve 32 in the first embodiment. The work port 8 of the electropneumatic parking brake valve unit 2 is connected here to a first redundancy valve supply port 32.1 of the redundancy valve 32, which forms the redundancy supply port 16 here. The first redundancy valve 32 is an electrically switchable 3/2 directional valve. In addition to the first redundancy valve supply port 32.1, the first redundancy valve 32 comprises a first redundancy valve work port 32.2, which, in the first embodiment of the electropneumatic parking brake device 1, forms the spring accumulator port 18 of the electropneumatic redundancy unit 10, and a first redundancy valve ventilation port 32.3, which forms the redundant ventilation 24 here.

The first electrically switchable redundancy valve 32 has two switching positions. A first redundancy valve ventilation position 32.4 shown in FIG. 2 is here also the ventilation position 22 of the electropneumatic parking redundancy unit 10. The first electrically switchable redundancy valve 32 is preloaded in this redundancy valve ventilation position 32.4 or the ventilation position 22 and automatically returns to this redundancy valve ventilation position 32.4, provided that a first electromagnet 32.6 of the first electrically switchable redundancy valve 32 is not supplied or energized with electrical energy. In the redundancy valve ventilation position 32.4, the first redundancy valve work port 32.2 is conductively connected to the first redundancy valve ventilation port 32.3 and a first working path 34 of the electropneumatic parking redundancy unit 10 is blocked or interrupted. The spring accumulator port 18 is then connected via the first electrically switchable redundancy valve 32 to the redundant ventilation 24, so that the spring brake cylinder 254 is vented via the electropneumatic parking redundancy unit 10.

In a first redundancy valve operating position 32.5, which is also the operating position 20 of the electropneumatic parking redundancy unit 10, the first redundancy valve supply port 32.1 and the first redundancy valve work port 32.2 are fluidically connected. In the first redundancy valve operating position 32.5, the first electrically switchable redundancy valve 32 releases the first working path 34. The parking pressure pFS controlled by the electropneumatic parking brake valve unit 2 thus reaches the parking brake cylinder 254 via the redundancy supply port 16 and the spring accumulator port 18.

The electropneumatic parking redundancy unit 10 can be controlled by a first control unit 36 for switching between the ventilation position 22 and the operating position 20. As explained with reference to FIG. 1, the first control unit 36 may be the secondary control unit 242. In other variants, however, the first control unit 36 can preferably also be formed by the unit for autonomous driving 218 or the service brake control unit 214. The first control unit 36 provides the first redundancy control signals SR1 at the first electrically switchable redundancy valve 32. Here, the first redundancy control signal SR1 has the form of electrical energy, which is provided at the first magnet 32.6, which then switches the first electrically switchable redundancy valve 32 to the redundancy valve operating position 32.5 and holds it there. For energization, the first electrically switchable redundancy valve 32 comprises first redundancy valve signal ports 32.7. One or more of the redundancy valve signal ports 32.7 are connected to the first control unit 36.

However, it may also be provided that in addition to the first control unit 36, a second control unit 38 for switching the electropneumatic parking redundancy unit 10 is connected to the first electrically switchable redundancy valve 32. In such variants, the first electrically switchable redundancy valve 32 can then be switched together by only one control unit from the first control unit 36 and the second control unit 38 or only by the first control unit 36 and the second control unit 38.

The first control unit 36 can be the autonomous driving unit 218, the service brake control unit 214, the secondary control unit 242 or the parking brake control unit 6. The second control unit 38 may be the autonomous driving unit 218, the service brake control unit 214, the secondary control unit 242 or the parking brake control unit 6, wherein the second control unit 38 is preferably a different control unit 36 from the first control unit 36.

In the first embodiment according to FIG. 2, the electropneumatic parking brake device 1 further comprises the protective device 30. This comprises a first protective port 30.1, which is connected to the spring accumulator port 18. A second protective port 30.2 of the protective device 30 is provided for receiving a service brake pressure pB1, pB2, pB3. The first protective port 30.1 is also referred to as the parking pressure port 30.1. The second protective port 30.2 is also referred to as the service pressure port 30.2. A third protective port 30.3 of the protective device 30, which is also referred to as the protective device work port 30.3, is connected to the spring brake cylinder 254. The protective device comprises a first shuttle valve 40, which transfers the higher of the pressures applied to the first protective port 30.1 and to the second protective port 30.2 to a second shuttle valve 42. The first shuttle valve 40 is thus a so-called select-high valve. This ensures that a parking pressure pFS and a service brake pressure pB1, pB2, pB3 are not simultaneously controlled at the spring brake cylinder.

FIG. 3 now shows a second embodiment of the electropneumatic parking brake device 1. According to the second embodiment, the electropneumatic parking redundancy unit 10 comprises a second working path 44, which runs parallel to the first working path 34 from the redundancy supply port 16 to the spring accumulator port 18. In this case, the redundancy supply port 16 and the spring accumulator port 18 are not formed by ports 32.1, 32.2 of the first electrically switchable redundancy valve 32. The first redundancy valve ventilation port 32.3 is connected here to a first redundant ventilation 24.1.

In the second working path 44, a second electrically switchable redundancy valve 46 is arranged here. This is substantially identical to the first electrically switchable redundancy valve 32. The second electrically switchable redundancy valve 46 comprises a second redundancy valve supply port 46.1, a second redundancy valve work port 46.2 and a second redundancy valve ventilation port 46.3. The second redundancy valve ventilation port 46.3 is connected to a second redundant ventilation 24.2. However, the first redundancy valve ventilation port 32.3 and the second redundancy valve ventilation port 46.3 could also be connected to a common redundant ventilation 24. The second electrically switchable redundancy valve 46 is preloaded in a second redundancy valve ventilation position 46.4. By supplying a second magnet 46.6 of the second electrically switchable redundancy valve 46, the second electrically switchable redundancy valve 46 can be switched to a second redundancy valve operating position 46.5. A second control unit 38 is preferably provided for controlling the second electrically switchable redundancy valve 46. According to various embodiments, the first control unit 36 is configured for controlling the first electrically switchable redundancy valve 32 and the second control unit 38 is provided for controlling the second electrically switchable redundancy valve 46.

In the second embodiment, the electropneumatic parking redundancy unit 10 is connected through from the ventilation position 22 to the operating position 20 either by switching the first electrically switchable redundancy valve 32 from the first redundancy valve ventilation position 32.4 to the first redundancy valve operating position 32.5 and/or by switching the second electrically switchable redundancy valve 46 from the second redundancy valve ventilation position 46.4 to the second redundancy valve operating position 46.5, in which operating position the parking pressure pFS provided at the redundancy supply port 16 is connected through to the spring accumulator port 18.

In the second embodiment of the electropneumatic parking brake device 1, the electropneumatic parking redundancy unit 10 adjacent to the spring accumulator port 18 comprises a selection valve 48. The selection valve 48 comprises a first selection valve port 48.1 connected to the first redundancy valve work port 32.2 and a second selection valve port 48 connected to the second redundancy valve work port 46.2.2. The selection valve 48 is a select-high valve and controls the higher of the pressures provided at the first selection valve port 48.1 and the second selection valve port 48.2 at the spring accumulator port 18. This can, for example, prevent a parking pressure pFS provided via the first working path 34 from being vented via the second electrically switchable redundancy valve 46, if this is in the second redundancy valve ventilation position 46.4 and vice versa. Thus, the spring brake cylinder 254 can still be pressurized with parking pressure pFS, if the second control unit 38, which controls the second electrically switchable redundancy valve 46, exhibits a fault.

In the event of a total electrical failure of the electronically controllable pneumatic brake system 200, both the first control unit 36, which is provided in the second embodiment for controlling the first electrically switchable redundancy valve 32, as well as the second control unit 38, which is provided in the second embodiment for controlling the second electrically switchable redundancy valve 46, have a fault. The first electrically switchable redundancy valve 32 and the second electrically switchable redundancy valve 46 then switch automatically and independently of the electropneumatic parking brake valve unit 2 in their respective redundancy valve ventilation positions 32.4, 46.4. In the event of a total electrical failure of the electronically controllable pneumatic brake system 200, the spring brake cylinder 254 is then vented via the first redundant ventilation 24.1 and/or the second redundant ventilation 24.2. The spring accumulator of the spring brake cylinder 254 then applies the parking brake and brakes the vehicle 300. Thus, even in the event of a total failure of the electronically controllable pneumatic brake system 200, an emergency braking function 50 can be provided.

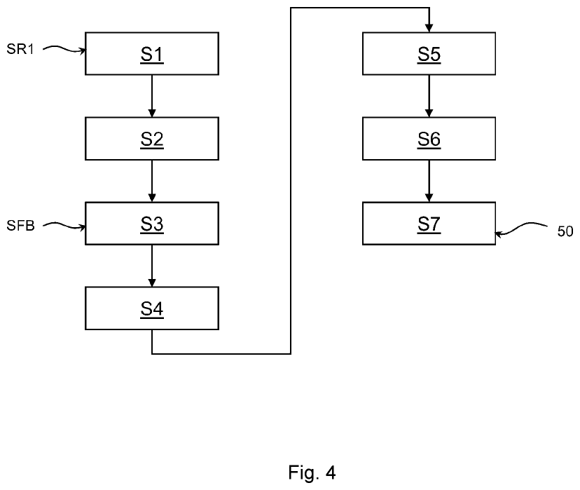

FIG. 4 illustrates a method 400 for operating an electronically controllable pneumatic brake system 200 of a vehicle 300 on the basis of a block diagram. The method is described here with reference to the brake system 200 shown in FIG. 1 and comprises a total of seven steps S1-S7, wherein also more steps or intermediate steps can be provided, and/or wherein the steps S1-S7 can also include partial steps.

In a step S1 of method 400, at least one redundancy switching signal SR1 is provided to the electropneumatic parking brake redundancy unit 10 of the electropneumatic parking brake device 1. As shown in FIG. 1, for example, the secondary control unit 242 can act as the first control unit 36 and provide the first redundancy switching signal SR1 to the electropneumatic parking brake redundancy unit 10. In a second step S2, the electropneumatic parking brake redundancy unit 10 switches to the operating position 20 in response to the provision (step S1) of at least one redundancy switching signal SR1. In a third step S3, which can also be carried out before the first step S2, before the second step S2 or simultaneously to the first step S1 and/or the second step S2, a parking brake signal SFB is provided to the parking brake control unit 6 of the electropneumatic parking brake valve unit 2 of the electropneumatic parking brake device 1. In the embodiment according to FIG. 1, this is done by the unit for autonomous driving 218. This causes an adjustment (step S4) of a parking pressure pFS by the electropneumatic parking brake valve unit 2 at its work port 8, the adjustment is effected as a function of the parking brake signals SFB provided on the electropneumatic parking brake valve unit 2. The parking brake redundancy unit 10 transmits the parking pressure pFS from its redundancy supply port 16 to its spring accumulator port 18 at the work port 8 of the electropneumatic parking brake valve unit 2 (step S5), because it was previously switched to the operating position 20. In a sixth step S6, a spring brake cylinder 254c, 254d, 254e, 254f of the electronically switchable pneumatic brake system 200 is pressurized with the spring accumulator port of the electropneumatic parking brake redundancy unit 10. This releases the spring brakes of the vehicle 300 and the vehicle 300 is ready for travel.

In the event of a fault, in particular a combined fault 402 of the service brake control unit 214 and the secondary control unit 242, the service brake actuators 208a-208f may no longer be used to brake the vehicle 300. In this case, however, neither the service brake control unit 214 nor the secondary control unit 242 can hold the electropneumatic parking brake redundancy unit 10 in the operating position 20. The electropneumatic parking brake redundancy unit 10 then switches independently of the electropneumatic parking brake valve unit 2 and in particular automatically (for example due to spring preload) to the ventilation position 22 and thus connects the spring accumulator port 18 with the redundant ventilation 24 (step S7). This causes the spring brake cylinders 254c-254f of the electronically switchable pneumatic brake system 200 connected to the spring accumulator port 18 to be vented and applied, whereby an emergency braking function 50 is implemented and the vehicle 300 is braked.

It is understood that the foregoing description is that of the preferred embodiments of the invention and that various changes and modifications may be made thereto without departing from the spirit and scope of the invention as defined in the appended claims.

### REFERENCES

1 Parking brake device
2 Parking brake valve unit
4 Supply port
6 Parking brake control unit
8 Work port
10 Parking brake redundancy unit
12 Parking pressure air path
16 Redundancy supply port
18 Spring accumulator port
20 Operating position
22 Ventilation position
24 Redundant ventilation
24.1 First redundant ventilation
24.2 Second redundant ventilation
26 First electrically switchable redundancy valve
28 Second electrically switchable redundancy valve
30 Protective device
30.1 First protective port, parking pressure port
30.2 Second protective port, service pressure port
30.3 Third protective port, protective work port
32 First redundancy valve
32.1 First redundancy valve supply port
32.2 First redundancy valve work port
32.3 First redundancy valve ventilation port
32.4 First redundancy valve ventilation position
32.5 First redundancy valve operating position
32.6 First electromagnet
32.7 First redundancy valve signal ports
34 First working path
36 First control unit
38 Second control unit
40 First shuttle valve
42 Second shuttle valve
44 Second working path
46 Second redundancy valve
46.1 Second redundancy valve supply port
46.2 Second redundancy valve work port
46.3 Second redundancy valve ventilation port
46.4 Second redundancy valve ventilation position
46.5 Second redundancy valve operating position
46.6 Second magnet
48 Selection valve
48.1 First selection valve port
48.2 Second selection valve port
50 Emergency braking function
200 Brake system
202 Rear axle brake circuit
203 Parking brake system
204 Front axle brake circuit
206 First compressed-air reservoir
207 Trailer brake circuit
208a-208f Service brake actuators
209 Trailer module
210 Second compressed-air supply
212 Service brake system
214 Service brake control unit
216 Vehicle bus
218 Unit for autonomous driving
220 First supply line
222 First voltage source
224 First service axle modulator
228 Front axle modulator
230 Service supply port
232.1 First service brake pressure port
232.2 Second service brake port
234 Wheel speed sensor
236 Second service axle modulator
237 Rear axle modulator
238 ABS valve
240 Central module
241 Secondary system
242 Secondary control unit
244 Second supply line
246 Second voltage source
248 Redundancy bus
250 Redundancy axle modulator
252 Redundancy brake pressure port
254, 254c-254f Spring brake cylinder
256 Second redundancy signal line
264 Foot brake pedal
300 Vehicle
302 Utility vehicle
400 Method
402 Fault
HA1 First rear axle
HA2 Second rear axle
pB1, pB2, pB3 Service brake pressures
pFS Parking pressure
SA Braking demand signals
SB Service brake signals
SD Wheel speed signals
SFB Parking brake signal
SFS Parking brake signal
SR Redundancy brake signals
SR1 Redundancy switching signal
VA Front axle
S1-S7 Steps of the method

1. An electropneumatic parking brake device for pressurizing and venting at least one spring brake cylinder of an at least partially electronically controllable pneumatic braking system for a vehicle, the electropneumatic parking brake device comprising:
an electropneumatic parking brake valve unit having a supply port for receiving reservoir pressure from a compressed-air reservoir and a parking brake control unit;
said parking brake valve unit being configured to control a parking brake pressure at least at one work port of said electropneumatic parking brake valve unit as a function of a parking brake signal;
an electropneumatic parking brake redundancy unit having a redundancy supply port, a spring accumulator port for at least indirectly connecting to the at least one spring brake cylinder and at least one redundant ventilation;
said redundancy supply port of said parking brake redundancy unit for receiving the parking brake pressure is connected to said at least one work port of said electropneumatic parking brake valve unit;
said electropneumatic parking brake redundancy unit having an operating position in which said redundancy supply port is connected to said spring accumulator port and a ventilation position in which said spring accumulator port is connected to said at least one redundant ventilation;
said electropneumatic parking brake redundancy unit being configured to be controlled at least by a first control unit for switching from said ventilation position to said operating position; and,
said electropneumatic parking brake redundancy unit being configured to switch to said ventilation position to provide an emergency braking function independently of said electropneumatic parking brake valve unit.

2. The electropneumatic parking brake device of claim 1, wherein said electropneumatic parking brake redundancy unit is configured to provide the emergency braking function if said first control unit has a fault.

3. The electropneumatic parking brake device of claim 1, wherein:
said electropneumatic parking brake redundancy unit has at least one first electrically switchable redundancy valve which in a first redundancy valve operating position releases a first working path connecting said redundancy supply port to said spring accumulator port so that said electropneumatic parking brake redundancy unit is in said operating position and which in a first redundancy valve ventilation position connects said spring accumulator port to the at least one redundant ventilation so that said electropneumatic parking brake redundancy unit is in said ventilation position; and,
said at least one first electrically switchable redundancy valve for switching from said first redundancy valve ventilation position to said first redundancy valve operating position is configured to be controlled by said first control unit.

4. The electropneumatic parking brake device of claim 3, wherein:
said electropneumatic parking brake redundancy unit further includes a second electrically switchable redundancy valve which in a second redundancy valve operating position releases a second working path connecting said redundancy supply port to said spring accumulator port so that said electropneumatic parking brake redundancy unit is in said operating position and which in a second redundancy valve ventilation position connects said spring accumulator port to the at least one redundant ventilation so that said electropneumatic parking brake redundancy unit is in said ventilation position.

5. The electropneumatic parking brake device of claim 4, wherein said first working path and said second working path of said electropneumatic parking brake redundancy unit are parallel working paths.

6. The electropneumatic parking brake device of claim 5, wherein said first working path and said second working path adjacent to said spring accumulator port are connected via a selection valve; and, said selection valve is configured to connect one of said first working path and said second working path carrying a higher pressure to said spring accumulator port.

7. The electropneumatic parking brake device of claim 1, wherein said electropneumatic parking brake redundancy unit is configured to be controlled by a second control unit for switching from said ventilation position to said operating position.

8. The electropneumatic parking brake device of claim 7, wherein at least one of:
said electropneumatic parking brake redundancy unit is configured to provide the emergency braking function if said first control unit fails or if said second control unit fails; and,
said electropneumatic parking brake redundancy unit is configured to provide the emergency braking function if said first control unit and said second control unit have a fault.

9. The electropneumatic parking brake device of claim 1, wherein said electropneumatic parking brake valve unit and said electropneumatic parking brake redundancy unit are connected in series along a parking pressure air path.

10. The electropneumatic parking brake device of claim 1 further comprising:
a protective device having a first parking pressure port, a service pressure port, and a protective device work port;
said first parking pressure port for receiving the parking brake pressure being connected to said spring accumulator port of said electropneumatic parking brake redundancy unit;
said service pressure port being connectable to a service brake circuit for receiving a service brake pressure; and,
said protective device being configured to control a higher pressure from the parking brake pressure and the service brake pressure at said protective device work port.

11. An electronically controllable pneumatic brake system for a vehicle, the electronically controllable pneumatic brake system comprising:
at least one parking brake actuator with a spring brake cylinder;
a first compressed-air reservoir to provide reservoir pressure;
an electropneumatic parking brake device including an electropneumatic parking brake valve unit having a supply port, for receiving the reservoir pressure from said first compressed-air reservoir, and a parking brake control unit;
said parking brake valve unit being configured to control a parking brake pressure at least at one work port of said electropneumatic parking brake valve unit as a function of a parking brake signal;
said electropneumatic parking brake device further including an electropneumatic parking brake redundancy unit having a redundancy supply port, a spring accumulator port for at least indirectly connecting to the at least one spring brake cylinder and at least one redundant ventilation;
said redundancy supply port of said parking brake redundancy unit for receiving the parking brake pressure is connected to said at least one work port of said electropneumatic parking brake valve unit;
said electropneumatic parking brake redundancy unit having an operating position in which said redundancy supply port is connected to said spring accumulator port and a ventilation position in which said spring accumulator port is connected to said at least one redundant ventilation;
said electropneumatic parking brake redundancy unit being configured to be controlled at least by a first control unit for switching from said ventilation position to said operating position; and,
said electropneumatic parking brake redundancy unit being configured to switch to said ventilation position to provide an emergency braking function independently of said electropneumatic parking brake valve unit;
said supply port of the electropneumatic parking brake valve unit being connected to said first compressed-air reservoir; and,
said spring accumulator port of said electropneumatic parking brake redundancy unit being connected to said spring brake cylinder.

12. The electronically controllable pneumatic brake system of claim 11, wherein:
said electropneumatic parking brake redundancy unit is configured to be controlled by a second control unit for switching from said ventilation position to said operating position; and,
said electropneumatic parking brake redundancy unit is configured to provide the emergency braking function only if said first control unit and said second control unit have a fault.

13. The electronically controllable pneumatic brake system of claim 11 further comprising:
a first voltage source;
a second voltage source; and,
said first voltage source being provided for supplying said first control unit with electrical voltage.

14. The electronically controllable pneumatic brake system of claim 13, wherein said first control unit can only switch said electropneumatic parking brake redundancy unit from the ventilation position to the operating position when said first voltage source and said second voltage source provide electrical energy.

15. The electronically controllable pneumatic brake system of claim 11 further comprising an autonomous driving unit; and, said autonomous driving unit being said first control unit.

16. The electronically controllable pneumatic brake system of claim 11 further comprising:
at least one service brake actuator;
a service brake system having a service brake control unit at least for controlling said at least one service brake actuator; and,
said service brake control unit being said first control unit.

17. The electronically controllable pneumatic brake system of claim 16 further comprising:
a secondary system having a secondary control unit; and,
said secondary system being configured to control said at least one service brake actuator if a fault is detected in said service brake system.

18. The electronically controllable pneumatic brake system of claim 17, wherein:
said electropneumatic parking brake redundancy unit is configured to be controlled by a second control unit for switching from said ventilation position to said operating position; and,
said secondary control unit is said second control unit.

19. The electronically controllable pneumatic brake system of claim 15 further comprising:
at least one service brake actuator;
a service brake system with a service brake control unit at least for controlling the at least one service brake actuator;
said electropneumatic parking brake redundancy unit being configured to be controlled by a second control unit for switching from said ventilation position to said operating position; and,
said service brake control unit being said second control unit.

20. A vehicle comprising:
at least one front axle;
at least one first rear axle; and,
the electronically controllable pneumatic brake system of claim 11.

21. The vehicle of claim 20, wherein the vehicle is a utility vehicle.

22. A method for operating an electronically controllable pneumatic brake system for a vehicle having a first control unit and a parking brake system having at least one spring brake cylinder and an electropneumatic parking brake device, the method comprising:
providing at least one redundancy switching signal to an electropneumatic parking brake redundancy unit of the electropneumatic parking brake device;
switching the electropneumatic parking brake redundancy unit to an operating position in response to providing the at least one redundancy switching signal;
providing a parking brake signal to a parking brake control unit of an electropneumatic parking brake valve unit of the electropneumatic parking brake device;
controlling a parking pressure by the electropneumatic parking brake valve unit at a work port of the electropneumatic parking brake valve unit as a function of the parking brake signal provided at the parking brake control unit;
transferring the parking pressure applied at the work port from a redundancy supply port of the electropneumatic parking brake redundancy unit to a spring accumulator port of the electropneumatic parking brake redundancy unit;
pressurizing the at least one spring brake cylinder connected to the spring accumulator port of the electropneumatic parking brake redundancy unit; and,
automatically switching the electropneumatic parking brake redundancy unit from the operating position to a ventilation position, independently of the electropneumatic parking brake valve unit, in which ventilation position the spring accumulator port is connected to a redundant ventilation of the electropneumatic parking brake redundancy unit in order to vent the at least one spring brake cylinder to provide an emergency braking function.
